(19) United States
(12) Patent Application Publication
(10) Pub. No.: US 2007/0022885 A1
(43) Pub. Date: Feb. 1, 2007

(54) Method and apparatus for preventing plate cylinder contamination during a plating process

(75) Inventors: Lev Zlatin, Portsmouth, NH (US); Mark Bernard Dumais, Kennebunk, ME (US); Michael Robert Lemelin, Madbury, NH (US); John Antonios Panteleos, York, ME (US)

Correspondence Address: DAVIDSON, DAVIDSON & KAPPEL, LLC, 485 SEVENTH AVENUE, 14TH FLOOR, NEW YORK, NY, 10018, US

(73) Assignee: Goss International Americas, Inc., Dover, NH (US)

(21) Appl. No.: 11/190,582

(22) Filed: Jul. 27, 2005

(51) Int. Cl. B41F 7/02

(52) U.S. Cl. 101/218

(57) ABSTRACT

In a preferred embodiment of the present invention, a printing press comprises a printing plate cylinder, a blanket cylinder and a support arrangement for mounting the printing plate cylinder in an opposed, movable relation to the blanket cylinder. A biasing arrangement is arranged and configured to bias the printing plate cylinder and the blanket cylinder toward one another to form a nip. According to a feature of the present invention, a stop member is arranged and configured to maintain a minimum spacing between the printing plate cylinder and the blanket cylinder.

### BACKGROUND OF THE INVENTION

In an offset printing operation, a printing plate cylinder is in a rotational contact with an opposed blanket cylinder. The plate cylinder carries a printing plate having a surface that contains an image to be printed and the blanket cylinder carries a printing blanket. The image is inked and transferred as an inked image to the blanket on the blanket cylinder at a nip between the plate cylinder and the blanket cylinder, during rotation of the opposed cylinders. The blanket on the blanket cylinder subsequently transfers the inked image to a material being printed, such as a web of paper transported by the rotating blanket cylinder.

A plating process is performed to change the plate carried by the printing plate cylinder to effect a printing job change. During a plating process in an offset printing press, the removal of the plate from the plate cylinder leaves the plate cylinder surface temporarily in direct contact with the opposed blanket cylinder, prior to insertion of the new plate. This can result in contamination of the surface of the printing plate cylinder. Plate surface contamination reduces the working life of each of the plate and blanket cylinders, thereby reducing the efficiency and cost effectiveness of the entire offset printing operation.

### SUMMARY OF THE INVENTION

The present invention provides a process and mechanism for preventing printing plate cylinder contamination during a plating process.

In a preferred embodiment of the present invention, a printing press comprises a printing plate cylinder, a blanket cylinder and a support arrangement for mounting the printing plate cylinder in an opposed, movable relation to the blanket cylinder. A biasing arrangement is arranged and configured to bias the printing plate cylinder and the blanket cylinder toward one another to form a nip. According to a feature of the present invention, a stop member is arranged and configured to maintain a minimum spacing between the printing plate cylinder and the blanket cylinder.

In accordance with another embodiment of the present invention, a method for performing a plating operation in an offset printing press comprises the step of biasing a printing plate cylinder toward engagement with an opposed blanket cylinder to form a nip there between, with the printing plate cylinder having a printing plate mounted thereon and the blanket cylinder having a blanket mounted thereon. According to a feature of the present invention, the printing plate is removed from the printing plate cylinder and the step of maintaining a spacing between the printing plate cylinder and the blanket of the blanket cylinder upon removal of the printing plate is performed.

In accordance with a third embodiment of the present invention, a method for installing a printing plate onto a printing plate cylinder in an offset printing press comprises the steps of biasing a printing plate cylinder toward engagement with an opposed blanket cylinder having a blanket, while maintaining a minimum spacing between the printing plate cylinder and the blanket on the blanket cylinder, and installing the printing plate on the plate cylinder by inserting one end of the printing plate into a gap on the printing plate cylinder and rotating the biased printing plate and blanket cylinders to form a nip between the printing plate and the blanket.

### BRIEF DESCRIPTION OF THE DRAWINGS

FIG. 1 is a side view of a prior art offset printing press, during a plating process.

FIG. 2 is a side view of an offset printing press, during a plating process as performed in accordance with a feature of the present invention.

FIG. 3 is a side view of the offset printing press of FIG. 2, when the printing plate is at 3 o'clock position.

FIG. 4 is a side view of the offset printing press of FIG. 2 with the printing and blanket cylinders omitted, for purposes of illustration, to show an adjustable stop according to a feature of the present invention.

FIG. 5 is another view of the adjustable stop feature of FIG. 4.

### DETAILED DESCRIPTION OF THE PREFERRED EMBODIMENTS

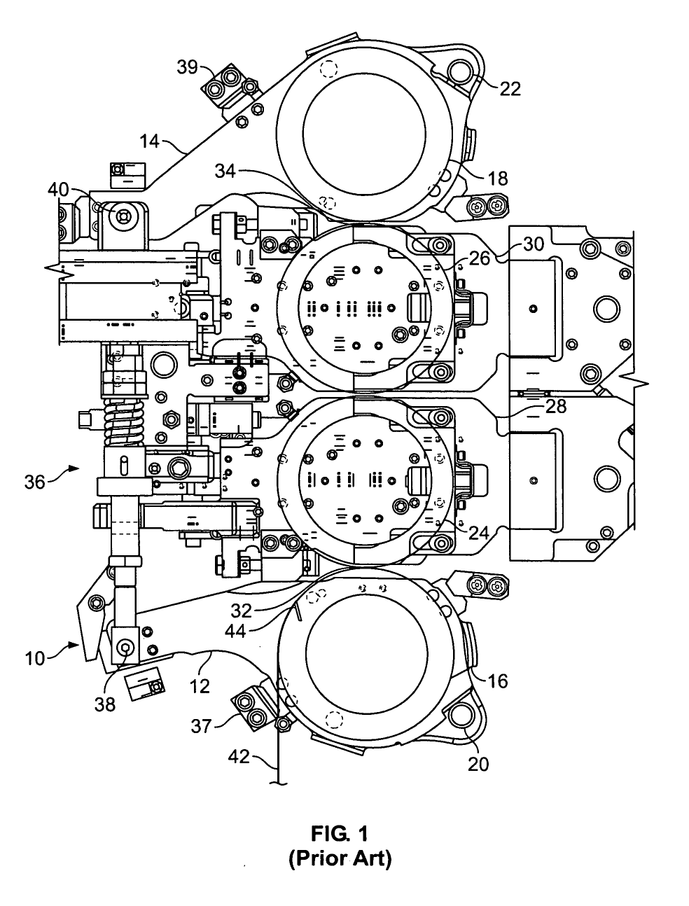

Referring now to the drawings, and initially to FIG. 1, there is illustrated a side view of a prior art offset printing press, during a plating process. A printing unit 10 includes pivotable printing plate support arms 12, 14, each arranged to rotatably mount an end of a respective printing plate cylinder 16, 18. Each one of a pair of blanket cylinders 24, 26 is rotatably supported by a support structure 28, 30, and is in rotational engagement with a corresponding one of the plate cylinders 16, 18. The engagement provided by the arrangement of the pivotable support arms 12, 14 and the support structures 28, 30 forms a nip 32, between the printing plate cylinder 16 and the blanket cylinder 24, and a nip 34 between the printing plate cylinder 18 and the blanket cylinder 26 for transfer of an inked image from a plate carried by each of the printing cylinders 16, 18, to a blanket carried by each of the corresponding blanket cylinders 24, 26, as is well known in the art.

Each of the printing plate support arms 12, 14 is mounted for pivoting movement about a respective pivot point 20, 22, such that the printing plate cylinders 16, 18 can be moved in a throw off process, as is known in the art. To that end, a biasing arrangement such as a pressure cylinder arrangement 36 is coupled to each of the printing plate cylinders 16, 18 at drive couplings 38, 40, respectively. The pressure cylinder arrangement 36 is selectively activated to separate the printing plate cylinders 16, 18 from the corresponding blanket cylinders 24, 26, during throw off. A pair of stops 37, 39 is arranged to limit the outward movement of the two printing plate cylinders 16, 18, respectively.

During a printing operation, the pressure cylinder arrangement 36 is set to bias the printing cylinders 16, 18 into pressure contact at the respective nips 32, 34 with the corresponding blanket cylinders 24, 26, as is also known in the art.

In FIG. 1, there is illustrated a plating process wherein a printing plate 42 is being removed from the printing plate cylinder 16. As clearly shown in FIG. 1, when a trailing end 44 of the printing plate 16 has passed the nip 32, the pressure bias of the pressure cylinder arrangement 36 causes the surface of the printing plate cylinder 16 to engage and be in direct contact with the surface of the opposed blanket cylinder 24. As noted above, this contact results in a contamination of the surfaces of both the printing plate cylinder 16, and the blanket on the blanket cylinder 24. Surface contamination is highly undesirable, reducing the working life of each of the plate and blanket, thereby reducing the efficiency and cost effectiveness of the entire offset printing operation.

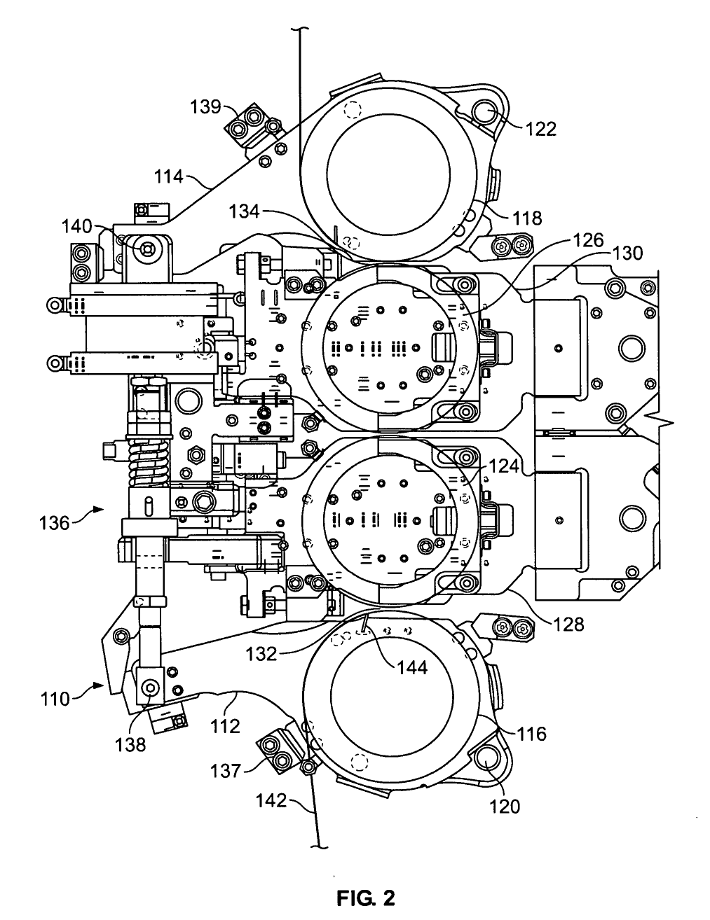

Referring now to FIG. 2, there is illustrated a side view of an offset printing press, during a plating process as performed in accordance with a feature of the present invention. In FIG. 2, the structure of an offset printing press 110 is identical to the basic structure of the prior art press 10 shown in FIG. 1. Support arms 112, 114, are each arranged to rotatably mount (about pivot points 120, 122) an end of a respective printing plate cylinder 116, 118.

Each one of a pair of blanket cylinders 124, 126 is rotatably supported by a support structure 128, 130, and is in rotational engagement with a corresponding one of the plate cylinders 116, 118. The rotational engagement forms a nip 132, between the printing plate cylinder 116 and the blanket cylinder 124, and a nip 134 between the printing plate cylinder 118 and the blanket cylinder 126 for transfer of an inked image from a respective plate mounted on each of the printing cylinders 116, 118, to a respective blanket mounted on each of the corresponding blanket cylinders 124, 126.

As in the prior art press 10 of FIG. 1, in the press shown in FIG. 2, each of the printing plate support arms 112, 114 is mounted for pivoting movement about a respective pivot point 120, 122, such that the printing plate cylinders 116, 118 can be moved in a throw off process, as is known in the art. A pressure cylinder arrangement 136 is coupled to each of the printing plate cylinders 116, 118 at drive couplings 138, 140, respectively. The pressure cylinder arrangement 136 is selectively activated to separate the printing plate cylinders 116, 118 from the corresponding blanket cylinders 124, 126, during throw off. A pair of stops 137, 139 is arranged to limit the outward movement of the two printing plate cylinders 116, 118, respectively. The pressure cylinder arrangement 136 also operates to bias the printing plate cylinders 116, 118 toward the corresponding, opposed blanket cylinders 124, 126 at the nips 132, 134, as in the press 10 of FIG. 1.

Pursuant to a feature of the present invention, during a plating operation, when an end 144 of a printing plate 142 disposed in the gap of the plate cylinder 166 has passed beyond the nip 132 in a plate removal operation (or prior to the end 144 entering the nip 132 in a plate installation operation), the printing plate cylinder 116 is arranged and configured to be in a spaced relation to the corresponding, opposed blanket cylinder 124, as shown in FIG. 2. Thus, contamination of the cylinder surfaces is prevented. When no printing plate 142 is present in the nip 132, the cylinders 116, 124 continue to be biased toward one another by action of the pressure cylinder arrangement 136, but remain spaced from one another.

In a preferred embodiment of the present invention, the spacing, when no printing plate is present in the nip, is set at a dimension less than the thickness of the printing plate 142.

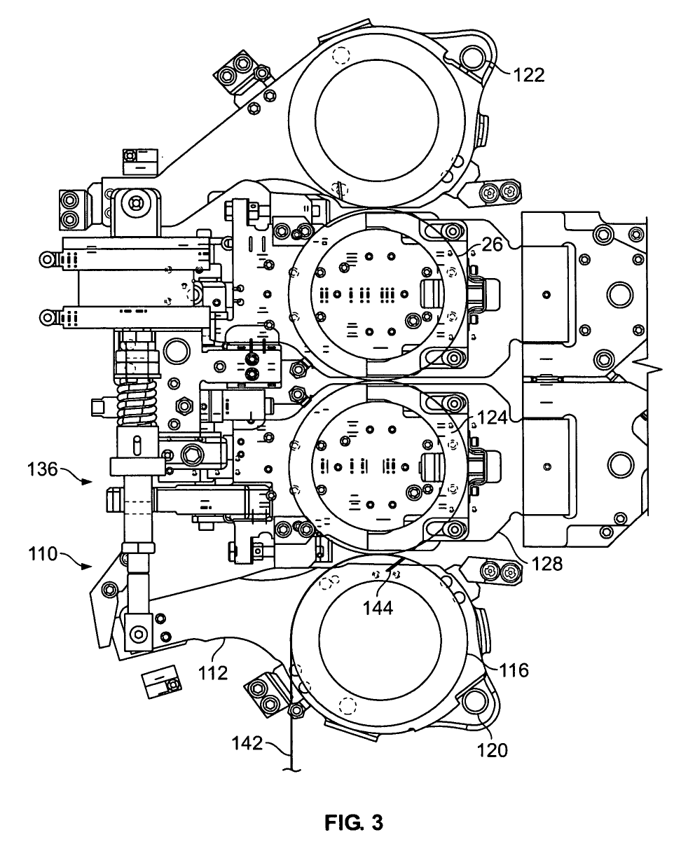

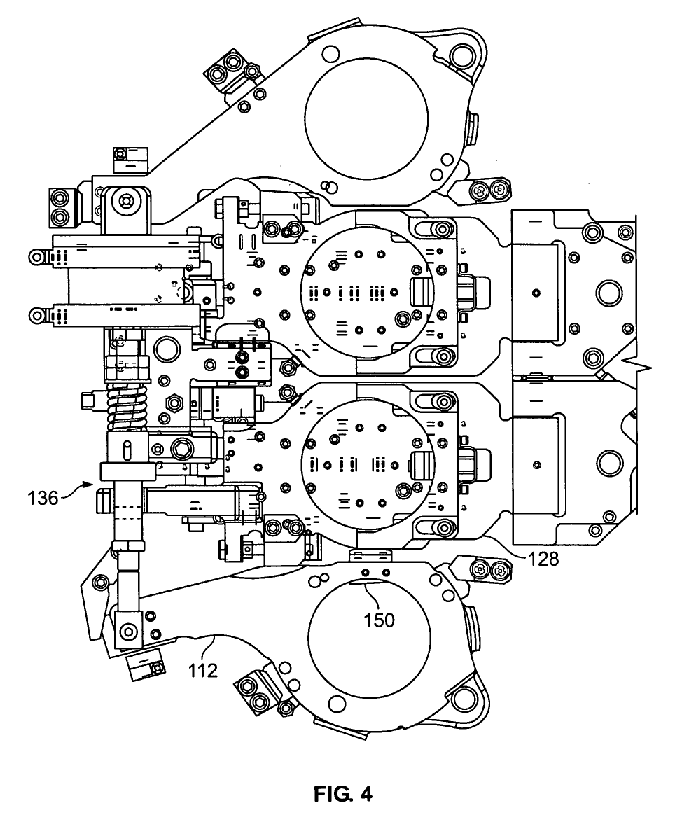

Referring now to FIG. 4, there is shown a side view of the offset printing press of FIG. 2 with the printing and blanket cylinders omitted for purposes of illustration of a preferred arrangement for maintaining the spacing. According to a feature of the present invention, a stop member 150 is adjustably mounted to the support arm 112 at a position opposite the opposed support structure 128. The dimensions and adjustment range for the stop member 150 are arranged and configured such that the stop member 150 engages the support structure 128 during a plating operation (when no printing plate is in the nip) to provide the spaced relation between the printing plate cylinder 116 and blanket cylinder 124, as clearly illustrated in FIG. 3. As noted above, the dimension of the spacing is adjusted and set to be less than the thickness of the removed printing plate 142 such that the opposed cylinders are biased toward one another by the pressure cylinder arrangement 136, but remain separated from one another.

FIG. 3 shows a side view of the offset printing press of FIG. 2, at a time after a printing plate 142 being installed has passed through the nip 132 (and has reached the 3 o'clock position), or at a time before a printing plate being removed has passed through the nip 132. At this point in an installation operation, for example, the end 144 is past the nip 132, pushing the cylinders 116, 124 apart to the thickness of the plate, causing impression between the cylinders for an effective printing operation. Thus, impression is maintained for printing when the printing plate 142 is present in the nip, but surface contact between the bare printing plate cylinder and the opposed blanket on the blanket cylinder is avoided by the spaced relation.

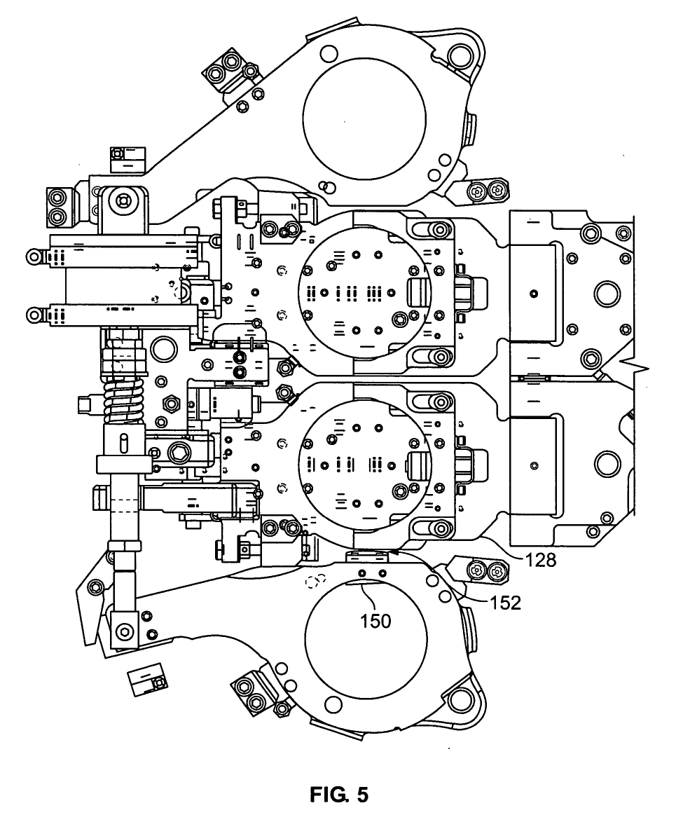

Inasmuch as the dimension of the spaced relation is less that the thickness of the printing plate, upon insertion of a printing plate 142 during a plating operation as shown in FIG. 3, the stop member 150 is displaced from contact with the opposed support structure 128. FIG. 5 shows a 0.2 mm clearance 152 between the stop member 150 and the opposed support structure 128 after insertion of the printing plate beyond the nip 132 as in FIG. 3. This results in the proper bias pressure between the opposed printing plate cylinder 116 and blanket cylinder 128 for impression.

In the preceding specification, the invention has been described with reference to specific exemplary embodiments and examples thereof. It will, however, be evident that various modifications and changes may be made thereto without departing from the broader spirit and scope of the invention as set forth in the claims that follow. The specification and drawings are accordingly to be regarded in an illustrative manner rather than a restrictive sense.

What is claimed is:

1. A printing press, which comprises:
a printing plate cylinder;
a blanket cylinder;
a support arrangement for mounting the printing plate cylinder in an opposed, movable relation to the blanket cylinder;
a biasing arrangement arranged and configured to bias the printing plate cylinder and the blanket cylinder toward one another to form a nip; and
a stop member arranged and configured to maintain a minimum spacing between the printing plate cylinder and the blanket cylinder.

2. The printing press of claim 1 wherein the support arrangement for mounting the printing plate cylinder in an opposed movable relation to the blanket cylinder includes a pivotable support arm for pivotably mounting the printing plate cylinder for movement toward and away from the opposed blanket cylinder, and wherein the stop member is mounted on the support arm for maintaining the minimum spacing between the printing plate cylinder and the blanket cylinder.

3. The printing press of claim 2 wherein the stop member is adjustably mounted on the support arm.

4. A method for removing a printing plate from an offset printing press, comprising the steps of:
biasing a printing plate cylinder toward engagement with an opposed blanket cylinder to form a nip there between, the printing plate cylinder having a printing plate mounted thereon and the blanket cylinder having a blanket mounted thereon; and
maintaining a spacing between the printing plate cylinder and the blanket on the blanket cylinder as the printing plate is removed from the plate cylinder.

5. The method of claim 4 wherein the spacing is of a dimension less that a thickness of the printing plate.

6. The method of claim 4 wherein a dimension of the spacing is adjustable to selectively set the spacing.

7. A method for installing a printing plate onto a printing plate cylinder in an offset printing press, comprising the steps of:
biasing a printing plate cylinder toward engagement with an opposed blanket cylinder having a blanket, while maintaining a minimum spacing between the printing plate cylinder and the blanket on the blanket cylinder; and
installing the printing plate on the plate cylinder by inserting one end of the printing plate into a gap on the printing plate cylinder and rotating the biased printing plate and blanket cylinders to form a nip between the printing plate and the blanket.
